(19) United States
(12) Patent Application Publication
(10) Pub. No.: US 2024/0353823 A1
(43) Pub. Date: Oct. 24, 2024

(54) APPARATUS, METHOD, AND COMPUTER PROGRAM PRODUCT FOR QUALITY REPORT WORKFLOW CONFIGURATION AND STATUS TRACKING

(71) Applicant: Honeywell International Inc., Charlotte, NC (US)

(72) Inventors: Ankit Singh, Apex, NC (US); Abhishek Hiremath, Bellevue, WA (US)

(21) Appl. No.: 18/138,641

(22) Filed: Apr. 24, 2023

(51) Int. Cl. G05B 19/418

(52) U.S. Cl. CPC G05B 19/41875; G05B 2219/32368

(57) ABSTRACT

A workflow configuration system for configuring and tracking quality report generation workflows receives via a workflow configuration interface input indicative of selected arrangements of graphical elements within quality report pane(s) of the workflow configuration interface and generates workflow configuration data based on the received input. The workflow configuration data is provided to a quality report generation system, which may be configured to perform report generation operations based on the workflow configuration data. The workflow configuration system presents a workflow status tracking interface and generates status alerts with respect to quality report generation workflows defined in the workflow configuration data based on quality report generation status data (e.g., generated by the quality report generation system) and/or on the quality report workflow configuration data.

### TECHNICAL FIELD

Embodiments of the present disclosure generally relate to quality reports, and specifically, in some examples, to configuring and tracking workflows for generating quality reports.

### BACKGROUND

Applicant has identified example technical challenges and difficulties associated with configuring and tracking workflows for generating quality reports. Through applied effort, ingenuity, and innovation, Applicant has solved problems relating to configuring and tracking workflows for generating quality reports.

### BRIEF SUMMARY

According to one aspect, example embodiments of the present disclosure include an apparatus comprising at least one processor and at least one non-transitory memory comprising program code stored thereon. The at least one non-transitory memory and the program code are configured to, with the at least one processor, cause the apparatus to at least: present a workflow configuration interface comprising one or more quality report panes, wherein each quality report pane of the one or more quality report panes corresponds to a quality report to be generated and to a workflow associated with generation of the quality report; receive, via the workflow configuration interface, input indicative of selected arrangements of graphical elements within the one or more quality report panes; and generate quality report workflow configuration data corresponding to each quality report pane of the one or more quality report panes based at least in part on the selected arrangement of graphical elements within the quality report pane and on predetermined graphical element arrangement parsing criteria. The quality report corresponding to each quality report pane of the one or more quality report panes is generated based at least in part on the quality report workflow configuration data corresponding to the quality report pane.

In some embodiments, the graphical elements comprise object graphical elements that represent objects associated with the generation of the quality reports, including particular users, particular reports to be generated, quality report section types, and/or data sources used to generate the quality reports, and connector graphical elements representing relationships between objects represented by the object graphical elements.

In some embodiments, receiving the input indicative of the selected arrangements of graphical elements within the one or more quality report panes comprises detecting drag-and-drop operations via the workflow configuration interface with respect to graphical elements displayed within the workflow configuration interface.

In some embodiments, the predetermined graphical element arrangement parsing criteria comprises a definition of one or more arrangements between graphical elements of particular types, each arrangement associated with a quality report generation workflow stage represented by the arrangement.

In some embodiments, the at least one non-transitory memory and the program code are configured to, with the at least one processor, further cause the apparatus to at least cause generation, transmission, and/or display of status alerts based at least in part on the quality report workflow configuration data.

In some embodiments, the at least one non-transitory memory and the program code are configured to, with the at least one processor, further cause the apparatus to at least provide the quality report workflow configuration data to a quality report generation system, which is configured to perform one or more quality report generation operations based at least in part on the quality report workflow configuration data. The quality report generation system may be configured to generate quality report generation status data based at least in part on performance of the one or more quality report generation operations. Moreover, in some embodiments, the at least one non-transitory memory and the program code are configured to, with the at least one processor, further cause the apparatus to at least present a workflow status tracking interface for displaying the quality report generation status data generated by the quality report generation system and/or to cause generation, transmission, and/or display of status alerts based at least in part on the quality report generation status data generated by the quality report generation system.

In some embodiments, the quality report corresponding to each quality report pane of the one or more quality report panes is associated with a pharmaceutical research, manufacturing, and/or distribution process, and the predetermined graphical element arrangement parsing criteria is configured specifically with respect to laboratory, production line, and/or material handling operations associated with the pharmaceutical research, manufacturing, and/or distribution process.

According to another aspect, embodiments of the present invention feature a method comprising: presenting a workflow configuration interface comprising one or more quality report panes, wherein each quality report pane of the one or more quality report panes corresponds to a quality report to be generated and to a workflow associated with generation of the quality report; receiving, via the workflow configuration interface, input indicative of selected arrangements of graphical elements within the one or more quality report panes; and generating quality report workflow configuration data corresponding to each quality report pane of the one or more quality report panes based at least in part on the selected arrangement of graphical elements within the quality report pane and on predetermined graphical element arrangement parsing criteria, wherein the quality report corresponding to each quality report pane of the one or more quality report panes is generated based at least in part on the quality report workflow configuration data corresponding to the quality report pane.

According to another aspect, embodiments of the present invention feature a computer program product comprising at least one non-transitory computer-readable storage medium having computer-readable program code portions stored therein. The computer-readable program code portions comprise an executable portion configured to: present a workflow configuration interface comprising one or more quality report panes, wherein each quality report pane of the one or more quality report panes corresponds to a quality report to be generated and to a workflow associated with generation of the quality report; receive, via the workflow configuration interface, input indicative of selected arrangements of graphical elements within the one or more quality report panes; and generate quality report workflow configuration data corresponding to each quality report pane of the one or more quality report panes based at least in part on the selected arrangement of graphical elements within the quality report pane and on predetermined graphical element arrangement parsing criteria. The quality report corresponding to each quality report pane of the one or more quality report panes is generated based at least in part on the quality report workflow configuration data corresponding to the quality report pane.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary block diagram of an environment in which embodiments of the present disclosure may operate;

FIG. 2 illustrates an exemplary block diagram of an example apparatus that may be specially configured in accordance with an example embodiment of the present disclosure;

FIG. 3 illustrates an exemplary workflow configuration system, in accordance with at least some example embodiments of the present disclosure;

FIG. 4 illustrates an exemplary workflow configuration screen presented within a graphical user interface, in accordance with at least some example embodiments of the present disclosure;

FIG. 5 illustrates an exemplary workflow status tracking screen presented within a graphical user interface, in accordance with at least some example embodiments of the present disclosure; and

FIG. 6 is a flowchart depicting an example process for configuring and tracking report generation workflows for quality reports, in accordance with at least some example embodiments of the present disclosure.

### DETAILED DESCRIPTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

In some exemplary scenarios, enterprises such as businesses or other organizations may produce products of various types via various research, manufacturing, and/or distribution processes associated with production of these products. In many such cases, these enterprises may develop, implement, and/or perform quality management systems, processes, and/or operations with respect to these research, manufacturing, and/or distribution processes with an aim toward ensuring that the quality of the products being produced meet a certain standard at a certain level of consistency. Sometimes, certain aspects of such quality management may even be required by laws and/or regulations. Production of certain types of products in particular, for example, may be subject to a relatively high degree of quality management regulation, including medical devices and pharmaceutical products, to list a few examples. For example, Annual Product Quality Review (APQR) is a quality management process that is often required in connection with production of pharmaceutical products, during which various research, manufacturing, and/or distribution processes, and any products resulting from said processes, are examined in detail to determine, for example, whether any changes to the products or processes are necessary. Findings from the APQR process are compiled and presented in a quality report.

Quality management software may be used to implement and/or facilitate quality management measures undertaken by enterprises with respect to the production of their products. More particularly, it may be possible for a quality management software system to facilitate the APQR report generation process. For example, the system may be configured to generate a quality report based on various sources of data accessible to the system and on interactions with and/or input (e.g., annotations) from various users associated with different portions (e.g., chapters) of the quality report. According to a typical workflow, for example, multiple users may, in conjunction with the system, work in parallel on their respective assigned portions of the quality report. The system may be configured to generate each portion of the quality report based on the corresponding assigned user's input and/or interactions in connection with the portion of the quality report and to generate the quality report to comprise all of the different portions once all of the portions of the report are completed. Additionally, such a system could also be configured to perform various operations with respect to a generated quality report, including facilitating review, revision, approval, and/or signature collection with respect to the report.

However, certain qualities of reports (such as those resulting from the APQR process) and/or certain aspects of generating such reports present a number of challenges, even when a quality management software system can be used to aid generation of the reports. For example, in one exemplary scenario mentioned for the purpose of illustration, a quality report for a particular product may comprise upwards of twenty different chapters, each of which may be assigned to a different user to work in parallel to complete the chapter. Moreover, an enterprise may produce several different products, each of which may be the subject of a different quality report. As a result, it can be very difficult, if not impractical, for an individual tasked with overseeing generation of such reports to set up and implement a workflow for each quality report and to track each report's progress, including the progress of each individual portion of each report and the progress of a report through the various stages of the report generation process.

In various embodiments, the presently disclosed workflow configuration system provides workflow configuration and status tracking interfaces configured to address at least the various problems and challenges described above with respect to quality report generation by, for example, allowing seamless workflow configuration and tracking for multiple quality reports from a number of different views. In some embodiments, the workflow configuration interface may comprise a drag-and-drop interface for configuring quality report workflows, including defining the various portions that will make up a report, assigning users to the various portions of the reports, associating different sources of data with the various portions of the reports, and/or defining various stages for the report generation process with respect to different users, to list a few examples. The workflow status tracking interface may display the progress of the report generation process, including a view of each user's assigned workflow steps with respect to each different report with, for example, color coding to indicate a completion status of each of the workflow steps. In some embodiments, the workflow configuration system may integrate with a quality report generation system configured to implement and/or facilitate the various workflow steps set up via the workflow configuration system and to receive status updates as various workflow steps are completed. Moreover, in some embodiments, the workflow configuration system may also cause generation, transmission, and/or presentation of status alerts in connection with the various workflows configured via the workflow configuration system based, for example, on status data generated by the quality report generation system in connection with report generation operations performed by the quality report generation system to generate the report.

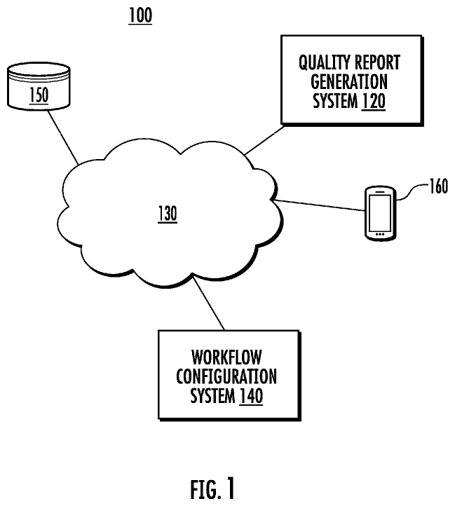

FIG. 1 illustrates an exemplary block diagram of an environment 100 in which embodiments of the present disclosure may operate. Specifically, FIG. 1 illustrates a workflow configuration system 140, a quality report generation system 120, one or more data repositories 150, and one or more user devices 160, all connected to a network 130.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

The one or more data repositories 150 may be configured to receive, store, and/or transmit data. In some embodiments, the one or more data repositories 150 may be configured to store enterprise data (e.g., product data, process data, system data, operational data, any report data that may be used to generate quality reports with respect to the one or more products, any related object data and/or metadata). In some embodiments, the one or more data repositories 150 may be configured to store data associated with generation (e.g., by the quality report generation system 120) of quality reports associated with the one or more products, including, for example, report generation status data, and/or data objects representing the quality reports themselves. Moreover, in some embodiments, the one or more data repositories 150 may be configured to store data associated with configuration of one or more workflows associated with the generation of the quality reports, including, for example, predefined and/or user-configurable parsing criteria for generating workflow configuration data and/or the workflow configuration data (e.g., generated by the workflow configuration system 140), to list a few examples. In various embodiments, some or all of the data stored in the one or more data repositories 150 may be stored in a shared memory system shared between the quality report generation system 120 and/or the workflow configuration system 140 and/or may be otherwise accessible to the quality report generation system 120 and/or the workflow configuration system 140.

The one or more user devices 160 may be associated with and/or operated by users of the quality report generation system 120, the workflow configuration system 140, and/or one or more operational systems associated with the one or more products and/or production of the one or more products. In one example, the operational system(s) associated with the one or more products and/or production thereof may cause data associated with the production of the one or more products to be transmitted to, to be displayed on, and/or to be used to generate data or interface elements displayed on the user devices(s) 160 and/or may cause one or more interfaces (e.g., user interfaces) to be presented via the user device(s) 160, which interface(s) may be configured to receive input comprising and/or used to generate any data associated with the one or more products and/or production thereof, including, in some examples, the product data, process data, system data, operational data, and/or report data. In another example, the quality report generation system 120 may cause data associated with generation of the quality reports with respect to the one or more products to be transmitted to, to be displayed on, and/or to be used to generate data or interface elements displayed on the user devices(s) 160 and/or may cause one or more interfaces (e.g., user interfaces) to be presented via the user device(s) 160, which interface(s) may be configured to receive input comprising and/or used to generate any data associated with generation of the quality reports. In another example, the workflow configuration system 140 may cause data associated with configuration and tracking of workflows associated with the generation of the quality reports to be transmitted to, to be displayed on, and/or to be used to generate data or interface elements displayed on the user devices(s) 160 and/or may cause one or more interfaces (e.g., user interfaces) to be presented via the user device(s) 160, which interface(s) may be configured to receive input comprising and/or used to generate any data associated with the configuration and tracking of the workflows for the quality reports.

The workflow configuration system 140 may be a computing system or device (e.g., server system) configured via hardware, software, firmware, and/or a combination thereof, to perform quality report workflow configuration and tracking functionality comprising, for example, presenting a workflow configuration interface, receiving (e.g., via the workflow configuration interface) workflow configuration data defining workflows associated with generation of quality reports to be generated (e.g., by the quality report generation system 120), accessing, retrieving, and/or displaying report status data associated with the workflows and/or the generation of the quality reports (e.g., report status data generated by the quality report generation system 120 in connection with generation of the quality reports), and/or causing generation, transmission, and/or presentation of status alerts associated with the workflows and/or the generation of the quality reports.

The quality report generation system 120 may be a computing system or device (e.g., server system) configured via hardware, software, firmware, and/or a combination thereof, to perform quality report generation functionality comprising, for example, presenting interface(s) configured to receive input used in generation of quality reports, receiving (e.g., via the presented interface(s)) the input used in generation of the quality reports, accessing and/or retrieving workflow configuration data (e.g., generated by the workflow configuration system 140), accessing and/or retrieving any stored data used in generation of the quality reports (e.g., product data, process data, system data, operational data), generating various iterations of the quality reports (e.g., based on input received via the presented interface(s), workflow configuration data, stored data), including generating discrete portions (e.g., chapters) of the quality reports and/or updating or otherwise transforming iterations of the quality reports in connection with progression through various phases in the report generation process, generating report status data associated with and/or in connection with generation of the quality reports, generation of any discrete portion of the quality reports, and/or progression through the various phases in the report generation process, and/or causing generation, transmission, and/or presentation of status alerts associated with the generation of the quality reports.

In various embodiments, the quality report generation system 120 and the workflow configuration system 140 may have varying degrees of integration with respect to each other. For example, the quality report generation system 120 and the workflow configuration system 140 may be configured to transmit and/or receive communications and/or data with respect to each other and/or access commonly accessible or shared data stores to exchange workflow configuration data and/or report status data. In another example, the workflow configuration system 140 may be a sub-system of and/or otherwise integrated as part of the quality report generation system 120. In another example, the quality report generation system 120 and the workflow configuration system 140 may be sub-systems of and/or otherwise integrated as part of a greater quality management software system configured to perform one or more quality management operations with respect to one or more products produced by one or more enterprises and/or one or more processes and/or systems associated with production of the one or more products.

While FIG. 1 illustrates certain components as separate, standalone entities communicating over the network 130, various embodiments are not limited to this configuration. In other embodiments, one or more components may be directly connected and/or share hardware or the like.

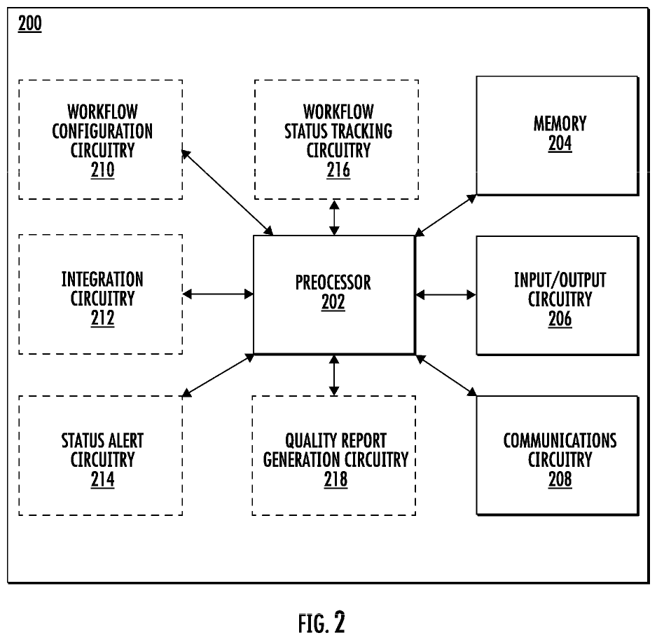

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. Examples of an apparatus 200 may include, but is not limited to, one or more components of one or more operational systems associated with the one or more products and/or production of the one or more products, a workflow configuration system 140, a quality report generation system 120, data repositories 150, and/or user devices 160. The apparatus 200 includes processor 202, memory 204, input/output circuitry 206, communications circuitry 208, and/or workflow configuration circuitry 210, integration circuitry 212, status alert circuitry 214, workflow status tracking circuitry 216, and/or quality report generation circuitry 218. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, a device, system, or apparatus, such as apparatus 200 of one or more components of one or more operational systems associated with the one or more products and/or production of the one or more products, a workflow configuration system 140, a quality report generation system 120, data repositories 150, and/or user devices 160, may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry embodying the memory 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device and/or other external computing device(s) in communication with the apparatus 200.

Workflow configuration circuitry 210 may be included in the apparatus 200 (e.g., an apparatus specifically corresponding to the workflow configuration system 140). The workflow configuration circuitry 210 may include hardware, software, firmware, and/or a combination thereof, designed and/or configured to request, receive, process, generate, and transmit data, data structures, control signals, and electronic information for configuring and tracking workflows associated with generation of quality reports, including performing any of the operations described herein with respect to generating workflow configuration data, displaying report status data, and/or causing generation, transmission, and/or presentation of status alerts.

Integration circuitry 212 may be included in the apparatus 200 (e.g., an apparatus specifically corresponding to the workflow configuration system 140 and/or the quality report generation system 120). The integration circuitry 212 may include hardware, software, firmware, and/or a combination thereof, designed and/or configured to request, receive, process, generate, and transmit data, data structures, control signals, and electronic information for functionality related to integration between the workflow configuration system 140 and the quality report generation system 120, including performing any of the operations described herein with respect to communication between the systems, accessing common data stores, and/or generating data by one system for interpretation, parsing, and/or use by the other system.

Status alert circuitry 214 may be included in the apparatus 200 (e.g., an apparatus specifically corresponding to the workflow configuration system 140 and/or the quality report generation system 120). The status alert circuitry 214 may include hardware, software, firmware, and/or a combination thereof, designed and/or configured to request, receive, process, generate, and transmit data, data structures, control signals, and electronic information for causing generation, transmission, and/or presentation of status alerts associated with generation of quality reports and/or corresponding workflows, including performing any of the operations described herein with respect to status alerts.

Workflow status tracking circuitry 216 may be included in the apparatus 200 (e.g., an apparatus specifically corresponding to the workflow configuration system 140). The workflow status tracking circuitry 216 may include hardware, software, firmware, and/or a combination thereof, designed and/or configured to request, receive, process, generate, and transmit data, data structures, control signals, and electronic information for tracking the status of workflows associated with the generation of quality reports, including performing any of the operations described herein with respect to receiving, retrieving, accessing, and/or presenting report status data.

Quality report generation circuitry 218 may be included in the apparatus 200 (e.g., an apparatus specifically corresponding to the quality report generation system 140). The quality report generation circuitry 218 may include hardware, software, firmware, and/or a combination thereof, designed and/or configured to request, receive, process, generate, and transmit data, data structures, control signals, and electronic information for generating quality reports, including performing any of the operations described herein with respect to generation of the quality reports.

In some embodiments, two or more of the sets of circuitries 202-218 are combinable. Alternatively, or additionally, one or more of the sets of circuitry 202-218 perform some or all of the operations and/or functionality described herein as being associated with another circuitry. In some embodiments, two or more of the sets of circuitry 202-218 are combined into a single module embodied in hardware, software, firmware, and/or a combination thereof. For example, in some embodiments, one or more of the sets of circuitry, for example the workflow configuration circuitry 210, may be combined with the processor 202, such that the processor 202 performs one or more of the operations described herein with respect to the workflow configuration circuitry 210.

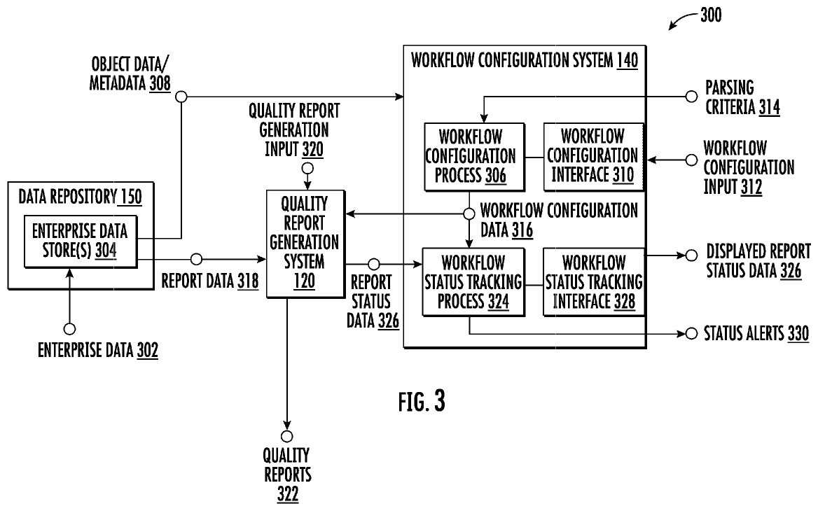

FIG. 3 is an illustration of an example workflow configuration system 140, in accordance with at least some example embodiments of the present disclosure. Specifically, FIG. 3 includes schematic depictions of the example workflow configuration system 140, including example internal processes and components of the workflow configuration system 140, and/or schematic depictions of the one or more data repositories 150 and the quality report generation system 120 in communication with the workflow configuration system 140, along with example data objects used by and/or produced by the depicted processes, components, and/or systems. The workflow configuration system 140 and/or apparatuses 200 associated therewith, for example, may be specially configured via hardware, software, firmware, and/or a combination thereof, to perform the various data processing and interactions described with respect to FIG. 3 to perform quality report workflow configuration and status tracking operations with respect to quality reports being generated for one or more products produced by one or more enterprises.

In the illustrated example, the workflow configuration system 140 comprises, in some examples, a workflow configuration process 306, a workflow configuration interface 310, a workflow status tracking process 324, and a workflow status tracking interface 328. Additionally, the one or more data repositories 150 comprise, in some examples, one or more enterprise data stores 304.

In an example scenario, enterprise data 302 for one or more enterprises may be generated, collected, captured, received, accumulated, and/or stored in connection with one or more products produced by the enterprise(s), one or more processes associated with production of the product(s), and/or one or more operational systems associated with the process(es) and/or product(s). Such enterprise data 302 may be stored in one or more enterprise data stores 304 associated with the enterprise(s).

In various embodiments, the enterprise data 302 may comprise any data associated with one or more products produced by one or more enterprises, including product data, process data, system data, operational data, any data that may be used (e.g., by the quality report generation system 120) to generate quality reports with respect to the one or more products, and/or any relevant object data and/or metadata, to list a few examples.

In one example, product data of the enterprise data 302 may comprise various items of data and/or metadata identifying and/or characterizing the product(s) produced by the enterprise with which the enterprise data 302 is associated, including measured, calculated, sensed, and/or otherwise determined values corresponding to various attributes associated with the product(s) in general and/or particular instances and/or batches of the product(s) that have been produced, to list a few examples.

In another example, process data of the enterprise data 302 may comprise various items of data and/or metadata identifying, defining, and/or characterizing the process(es) associated with the production of the product(s) (e.g., research processes, manufacturing processes, testing processes, distribution processes, quality management processes, business processes), including measured, calculated, sensed, manually configured, and/or otherwise determined values corresponding to various attributes associated with the process(es), to list a few examples.

In another example, system data of the enterprise data 302 may comprise various items of data and/or metadata identifying, defining, establishing configuration parameters for, and/or characterizing operational system(s) associated with the process(es) and/or products (e.g., any computing, mechanical, automation, monitoring, control, laboratory, manufacturing, and/or distribution systems or equipment), including measured, calculated, sensed, manually configured, and/or otherwise determined values corresponding to various attributes associated with the operational system(s), environments where the system(s) are installed, components (e.g., equipment, assets) comprised by the system(s), configuration parameters defining functionality of the system(s) and/or its components, and/or operational sessions during which the system(s) have previously operated, to list a few examples.

In another example, object data and/or metadata of the enterprise data 302 may comprise various items of data and/or metadata (e.g., such as that embodied in object data/metadata 308) identifying, defining, and/or characterizing various real or virtual objects associated with the product(s) or production thereof and/or any relationships between said objects. In some embodiments, object data and/or metadata of the enterprise data 302 may comprise user data identifying any users (e.g., of the operational system(s), of the quality report generation system 120, of the workflow configuration system 140) and/or user accounts of the users and/or specifying identifiers, names, display names, roles (e.g., within the various process(es) associated with production of the product(s) and/or generation of the quality reports), and/or access permissions with respect to the users and the enterprise data 302. In some embodiments, object data and/or metadata of the enterprise data 302 may comprise data set metadata identifying and/or classifying particular data sets of the enterprise data 302, which data sets may correspond to particular portions (or portion types) of quality reports to be generated with respect to the product(s). In some embodiments, object data and/or metadata of the enterprise data 302 may comprise report metadata identifying and/or characterizing various features of quality reports, including, for example, identifiers, display names, and/or template text associated with various types of quality report portions (e.g., chapters) along with relationships between the various types and/or other objects (e.g., data sets).

In some embodiments, the enterprise data 302 may be generated by, within, using, and/or in connection with operation of the operational system(s) associated with the product(s) and/or process(es) related to production of the product(s). In some examples, the operational system(s) may be configured to monitor, implement, control, and/or facilitate various research, manufacturing, testing, distribution, quality management, and/or business processes associated with production of the product(s), and the operational system(s) may comprise various components, including, in some examples, controllers, sensors, actuators, laboratory devices, tools, manufacturing devices, distribution devices, computing devices (or any combination thereof) configured to perform some or all of the functionality involved in the monitoring, implementing, controlling, and/or facilitating of the various processes. The operational system(s) may be configured, in some examples, to monitor and/or control various physical aspects of the process(es) and/or associated environments. In some examples, the operational system(s) may include computer, software, and/or network systems associated with the production of the product(s), including one or more enterprise networks (e.g., comprising user devices, server devices, and/or networking devices connected to each other via one or more networks), one or more cloud-based or on-site, centralized and/or distributed software systems, content management systems, knowledge management systems, project management systems, customer relationship management systems, human resources management systems, and/or any systems associated with internal and/or external processes and/or operations related to the production of the product(s). The operational system(s), and/or any system(s) or device(s) configured to monitor, control, and/or communicate with the operational system(s), may generate various types of data resulting from and/or characterizing operation of these system(s), and such data may be captured, collected, and/or aggregated as part of the enterprise data 302.

In some embodiments, the enterprise data 302 may comprise and/or may be generated based at least in part on input received from one or more users (e.g., via user interfaces presented on the user device(s) 160) in connection with the product(s) and/or process(es) related to production of the product(s).

In various embodiments, the enterprise data 302 may be associated with and/or generated during or in connection with any phase of production of the product(s) and/or any corresponding process(es), including any research, manufacturing, testing, distribution, quality management, and/or business phases or processes.

In various embodiments, the enterprise data 302 may comprise external data accessed, retrieved, collected, and/or received from one or more external sources of data, the external data being associated with and/or related to the product(s) and/or various process(es) associated with the product(s). For example, external data of the enterprise data 302 may comprise data retrieved from archives, databases, research indexes, and/or data sets publicly available, including possibly data identifying and/or characterizing quality management specifications related to the product(s) and/or various process(es) associated with production of the product(s), to name an example.

In various embodiments, the workflow configuration system 140 may be configured to perform various quality report workflow configuration and tracking operations (to be described) with respect to quality reports 322 (e.g., generated by the quality report generation system 120).

In some embodiments, the workflow configuration system 140 may be configured to retrieve object data/metadata 308 from among the enterprise data 302 stored in the enterprise data store(s) 304. This object data/metadata 308 may correspond to and/or comprise the object data and/or metadata of the enterprise data 302 as previously defined, including, for example, the user data, the data set metadata, and/or the report metadata. The workflow configuration system 140 may be configured to perform the various quality report workflow configuration and tracking operations based at least in part on the object data/metadata 308 retrieved from the enterprise data store(s) 304, including, for example, presenting some or all of the retrieved object data/metadata 308 within various interfaces (e.g., workflow configuration interface 310, workflow status tracking interface 328), generating the various interfaces based at least in part on the object data/metadata 308, and/or generating various data objects (e.g., workflow configuration data 316, status alerts 330) based at least in part on (e.g., derived from, referencing, and/or comprising) the object data/metadata 308.

More particularly, in some embodiments, the workflow configuration process 306 of the workflow configuration system 140 may be configured to present the workflow configuration interface 310, which may be configured to receive input (e.g., from and/or based on input received and/or detected via the user device(s) 160) associated with one or more quality reports 322 to be generated (and/or one or more quality report workflows to be configured in connection with generation of the quality reports 322), including, for example, workflow configuration input 312. For example, the workflow configuration process 306 may be configured to present the workflow configuration interface 310 within a graphical user interface (GUI) rendered on one or more displays of the user device(s) 160, the workflow configuration interface 310 comprising one or more interactable elements configured to receive input and/or selections (e.g., of the workflow configuration input 312) that may be used to configure one or more quality report generation workflows that may be used, in turn, to generate (e.g., by the quality report generation system 120) the quality reports 322 and/or to track the status of the generation of the quality reports 322. As previously mentioned, the workflow configuration process 306 may be configured to generate and/or present the workflow configuration interface 310 based at least in part on the object data/metadata 308 retrieved from the enterprise data store(s) 304, including, in one example, rendering graphical elements representing various objects defined in the object data/metadata 308 along with interactable elements for receiving workflow configuration input 312 with respect to the various objects defined in the object data/metadata 308 and represented by the various graphical elements.

In various embodiments, the input received via the workflow configuration interface 310 (e.g., the workflow configuration input 312) may comprise data based upon which the quality report generation workflow(s) may be determined and/or defined.

More particularly, in some embodiments, the workflow configuration interface 310 presented by the workflow configuration process 306 may comprise one or more quality report panes, each corresponding to a quality report 322 to be generated and/or to a workflow associated with the generation of the quality report 322. Moreover, the workflow configuration interface 310 may comprise graphical elements (e.g., graphically rendered as part of the workflow configuration interface 310), each of which may represent, for example, a particular object defined in the object data/metadata 308 and/or a type of relationship between such objects. The workflow configuration interface 310 may comprise one or more interactable elements configured to receive input indicative of selected arrangements of some or all of the graphical elements within the quality report pane(s). The workflow configuration input 312 received via the workflow configuration interface 310 may be indicative of the selected arrangements of the graphical elements within the quality report pane(s) and may additionally comprise, for example, data identifying the objects represented by the various quality report pane(s) and corresponding graphical elements included in the selected arrangements (e.g., with reference to objects defined in the object data/metadata 308). The selected arrangements of the graphical elements may include positions of graphical elements with respect to the quality report pane(s), relative positions of the graphical elements with respect to each other, and/or contact or connection between two or more graphical elements, to list a few examples.

In some embodiments, receiving the workflow configuration input 312 via the workflow configuration interface 310 may comprise detecting drag-and-drop operations via the workflow configuration interface 310 with respect to graphical elements displayed within the workflow configuration interface 310. For example, the drag-and-drop operations may comprise selection of a graphical element (e.g., representing an object defined in the object data/metadata 308), dragging or moving of the selected graphical element into one of the quality report panes, and, more particularly, dragging or moving the of the selected graphical element into a particular position within the quality report pane and/or into a particular arrangement with respect to other graphical elements within the quality report pane.

In various embodiments, the workflow configuration process 306 may be configured to generate workflow configuration data 316. The workflow configuration data 316 may comprise, with respect to one or more quality reports 322, a definition and/or identification of a data object representing a particular quality report 322, definition(s) of data object(s) representing one or more workflow steps associated with generation of the particular quality report 322 (e.g., corresponding to portions of the quality report and/or phases in the quality report generation process and/or to chapter types defined in the object data/metadata 308), assignment of one or more users and/or corresponding user accounts (e.g., as defined in the object data/metadata 308) to the defined workflow step(s), and/or association of various data sets (e.g., as defined in the object data/metadata 308) to the defined workflow step(s), to list a few examples.

In some embodiments, the workflow configuration process 306 may be configured to generate workflow configuration data 316 based at least in part on the workflow configuration input 312 received via the workflow configuration interface 310. More particularly, the workflow configuration process 306 may be configured to generate workflow configuration data 316 corresponding to each quality report pane of the workflow configuration interface 310 (and/or corresponding to each quality report 322 represented by each quality report pane) based at least in part on the selected arrangement of graphical elements within that quality report pane (e.g., as indicated or defined in the workflow configuration input 312).

In some embodiments, the workflow configuration process 306 may be configured to generate the workflow configuration data 316 based at least in part on predefined (and/or user-configurable) graphical element arrangement parsing criteria (embodied in parsing criteria 314, for example). The parsing criteria 314 may comprise data sufficient for the workflow configuration process 306 to generate the workflow configuration data 316 by interpreting the workflow configuration input 312 (e.g., including the selected arrangements of graphical elements within the quality report pane(s)) and deriving the workflow configuration data 316 from the interpreted workflow configuration input 312. In one example, the parsing criteria 314 may comprise a definition of one or more arrangements between graphical elements of particular types, each arrangement associated with a quality report generation workflow stage represented by the arrangement.

More particularly, in some embodiments, the parsing criteria 314 may define various types of workflow step(s), types of phases in the report generation process, and/or types of relationships between objects (e.g., defined in the object data/metadata 308), with each of these defined types being associated with a representation of a type of arrangement of graphical elements that may occur within the quality report pane(s) (and corresponding workflow configuration input 312) and may be indicative of and/or representative of the defined type. The workflow configuration process 306 may be configured to generate the workflow configuration data 316 by determining whether any of the types of arrangements of graphical elements defined in the parsing criteria 314 correspond to (or match) any of the selected arrangements of graphical elements indicated in the workflow configuration input 312 and, for each correspondence (or match) between a type of arrangement defined in the parsing criteria 314 and a selected arrangement indicated in the workflow configuration input 312, including in the workflow configuration data 316 a definition of a particular workflow step, report generation phase, and/or relationship of the type corresponding to the matching arrangement in the parsing criteria 314. The workflow configuration process 306 may be configured to generate (e.g., as part of the workflow configuration data 316) each definition of a particular workflow step, report generation phase, and/or relationship with respect to particular objects (e.g., defined in the object data/metadata 308) based at least in part on references to the particular objects included in the workflow configuration input 312 and associated with the selected arrangements of graphical elements. In this way, for example, the workflow configuration process 306 may be configured to combine and/or cross-reference the particular workflow configuration input 312 received via the workflow configuration interface 310 with the predefined parsing criteria 314 in order to derive, determine, and/or define a representation of a report generation workflow.

In various embodiments, the quality report generation system 120 may be configured to perform one or more report generation operations associated with generation of the quality reports 322.

In some embodiments, the report generation operation(s) performed by the quality report generation system 120 may comprise retrieving report data 318 from among the enterprise data 302 stored in the enterprise data store(s) 304. The report data 318 may comprise any data from among the enterprise data 302 that may be used in generation of the quality reports 322.

In some embodiments, the report generation operation(s) performed by the quality report generation system 120 may comprise prompting for, receiving, and/or processing quality report generation input 320 in connection with generation of the quality reports 322. For example, the quality report generation system 120 may be configured to cause one or more interfaces (e.g., user interfaces, GUIs) to be presented via the user device(s) 160, which interface(s) may be configured to prompt for and/or receive the quality report generation input 320. The quality report generation input 320 may comprise data indicative of various types of user input and/or selections that may determine how the quality reports 322 are generated, including text data input via the interface(s) (e.g., annotations, written portions of the report) to be included in the report, selected images or other graphical features to be included in the report, selected formatting parameters to determine how the generated report is formatted, input indicative of electronic signatures to be included in and/or applied to the generated report, input indicative of completion (e.g., by a user) of various workflow step(s) and/or report generation phases and/or advancement to a succeeding step/phase, and/or input indicative of approval (e.g., by users) of various drafts, iterations, and/or portions of the generated report, to list a few examples.

In some embodiments, the report generation operation(s) performed by the quality report generation system 120 may comprise generating and/or outputting the quality reports 322, including generating one or more particular report portions (e.g., chapters) associated with a quality report 322 and/or generating a complete quality report 322 comprising all particular report portions (e.g., chapters) generated in connection with the quality report 322. In one example, the quality report generation system 120 may be configured to generate the quality reports 322 based at least in part on the retrieved report data 318, the received quality report generation input 320, and/or any data derived from the retrieved report data 318 and/or quality report generation input 320 by including some or all of data within the generated quality reports 322, formatting the quality reports 322 based at least in part on the data, processing and/or transforming successive iterations or drafts of the quality reports 322 based at least in part on the data (e.g., transforming an intermediate draft to a final draft in response to receiving input indicative of an electronic signature, completion of a review phase, and/or assignment of an approved status with respect to the intermediate draft), and/or generating particular portions of the quality reports 322 in a particular order or sequence based at least in part on the data (e.g., generating a first portion of the report in response to receiving input indicative of completion of a corresponding first phase of the report generation process or in response to successfully retrieving report data 318 sufficient for completion of the first phase followed by generating subsequent portions of the report), to list a few examples.

In some embodiments, the quality report generation system 120 may be configured to perform the report generation operation(s) based at least in part on the workflow configuration data 316 generated by the workflow configuration process 306. For example, the workflow configuration process 306 may be configured to generate the workflow configuration data 316 to include a representation of a report generation workflow that may be interpretable (e.g., by the quality report generation system 120, by other processes of the workflow configuration system 140) in performing various operations associated with generating the quality reports 322 and/or tracking the status of such generation. In some embodiments, the workflow configuration system 140 may be configured to generate the workflow configuration data 316 such that formatting and/or contents of the data may be suitable for parsing and/or interpretation by the quality report generation system 120.

In one example, particular portions of the enterprise data 302 included in the retrieved report data 318 may correspond to and/or may be determined based at least in part on the workflow configuration data 316. For example, in response to identifying within the workflow configuration data 316 a workflow associated with a particular product, the quality report generation system 120 may be configured to retrieve (as part of the report data 318) one or more portions of the enterprise data 302 specifically associated with that particular product and to perform the report generation operation(s) with respect to and/or based at least in part on the retrieved portion(s) of the enterprise data 302. In another example, in response to identifying within the workflow configuration data 316 a particular report portion (e.g., chapter) defined as part of a workflow for generating a quality report, the quality report generation system 120 may be configured to retrieve (as part of the report data 318) one or more portions of the enterprise data 302 specifically associated with the particular report portion identified within the workflow configuration data 316. In another example, in response to identifying within the workflow configuration data 316 a particular data set indicated to be associated with a workflow step, the quality report generation system 120 may be configured to retrieve (as part of the report data 318) one or more portions of the enterprise data 302 specifically associated with the particular data sets, including the particular data sets themselves or portions thereof.

In another example, the report generation system 120 may be configured to prompt for, receive, and/or process the quality report generation input 320 based at least in part on the workflow configuration data 316. For example, in response to identifying within the workflow configuration data 316 a workflow associated with a particular product, the quality report generation system 120 may be configured to generate and present the interface(s) for receiving the quality report generation input 320 to include prompts for input and/or to display data specific to that particular product. In another example, in response to identifying within the workflow configuration data 316 a particular report portion (e.g., chapter) defined as part of a workflow for generating a quality report, the quality report generation system 120 may be configured to generate and present the interface(s) for receiving the quality report generation input 320 to include prompts for input and/or to display data specifically associated with that particular report portion. In another example, in response to identifying within the workflow configuration data 316 a particular data set indicated to be associated with a workflow step, the quality report generation system 120 may be configured to generate and present the interface(s) for receiving the quality report generation input 320 to include prompts for input and/or to display data specifically associated with that particular data set.

In some embodiments, the quality report generation system 120 may be configured to perform the report generation operation(s) in a particular order or sequence based at least in part on the workflow configuration data 316. For example, in response to identifying within the workflow configuration data 316 a particular sequence or order of workflow steps and/or report generation phases, the quality report generation system 120 may be configured to perform the report generation operation(s) corresponding to the various steps and/or phases according to the particular sequence or order of the steps/phases defined in the workflow configuration data 316.

In some embodiments, the quality report generation system 120 may be configured to perform the report generation operation(s) with respect to particular users and/or corresponding user accounts based at least in part on the workflow configuration data 316. For example, in response to identifying within the workflow configuration data 316 an assignment of a user to a particular workflow step or report generation phase, the quality report generation system 120 may be configured to perform any report generation operation(s) associated with that particular step/phase specifically with respect to the assigned user, including performing the report generation operation(s) specifically in conjunction with a particular user device 160 associated with the assigned user and/or presenting any interface(s) for receiving any quality report generation input 320 associated with that particular step/phase specially to the assigned user (e.g., via the user device 160 associated with the assigned user), to list a few examples.

In various embodiments, the quality report generation system 120 may be configured to generate report status data 326 in connection with and/or based at least in part on performance of the various report generation operation(s). For example, in response to completion of a particular report generation operation, the quality report generation system 120 may be configured to generate and/or update the report status data 326 to reflect and/or indicate that the particular report generation operation was completed. In some embodiments, the quality report generation system 120 may be configured to generate the report status data 326 to be interpretable by the workflow configuration system 140, including, for example, generating the report status data 326 such that formatting and/or contents of the data may be suitable for parsing and/or interpretation by the workflow configuration system 140, which may be configured to perform the various workflow status tracking operations based at least in part on the report status data. More particularly, the quality report generation system 120 may be configured to generate the report status data 326 to have a structure, organization, and/or format analogous to that of the workflow configuration data 316 and/or with reference to one or more items of data (e.g., workflow steps, report generation phases) originally defined in the workflow configuration data 316. In one example, the quality report generation system 120 may be configured to indicate any completion status data in the report status data 326 specifically with respect to particular workflow steps and/or report generation phases defined in the workflow configuration data 316.

In one example, in response to completion of all report generation operations corresponding to a particular workflow step and/or report generation phase originally defined in the workflow configuration data 316, the quality report generation system 120 may be configured to generate and/or update the report status data 326 to reflect and/or indicate that the particular step/phase was completed. In another example, in response to completion of some (but not all) report generation operations corresponding to a particular step/phase, the quality report generation system 120 may be configured to generate and/or update the report status data 326 to reflect and/or indicate that the particular step/phase is in progress and/or was started but not completed. In another example, in response to determining that none of the report generation operations corresponding to a particular step/phase have been completed, the report generation system 120 may be configured to generate and/or update the report status data 326 to reflect and/or indicate that the particular step/phase has not been started.

In various embodiments, the quality report generation system 120 may be configured to generate and/or update the report status data 326 by adding and/or updating data identifying, characterizing, and/or providing display labels associated with particular types of statuses with respect to particular types of workflow steps and/or report generation phases. For example, in addition to indicating, for certain steps/phases a binary completion status (e.g., complete, incomplete) the report status data 326 may comprise data characterizing the completion status and/or describing the current iteration of a report (or portion thereof), including, for example, labels or tags indicating which particular operations still remain to be completed, which particular operations were most recently completed, which particular operations are currently in progress, approval or rejection statuses associated with particular reports (or portions thereof), and/or draft status of a particular report (or portion thereof), to list a few examples.

In various embodiments, the workflow configuration system 140 may be configured to perform various workflow status tracking operations based at least in part on the report status data 326 generated by the quality report generation system 120.

More particularly, in some embodiments, the workflow status tracking process 324 of the workflow configuration system 140 may be configured to present the workflow status tracking interface 328, which may be configured to present some or all of the report status data 326. For example, the workflow status tracking process 324 may be configured to present the workflow status tracking interface 328 within a GUI rendered on one or more displays of the user device(s) 160, the workflow status tracking interface 328 comprising one or more graphical elements representing various items of data defined in the workflow configuration data 316 (e.g., workflow steps, report generation phases, users assigned to the steps/phases), with the arrangement and/or visual characteristics of the rendered graphical element(s) being determined based at least in part on and/or indicative of corresponding items of data in the report status data 326.

Moreover, in some embodiments, the workflow status tracking process 324 may be configured to cause generation, transmission, and/or presentation of one or more status alerts 330 based at least in part on the report status data 326. The status alerts 330 may be generated by the workflow status tracking process 324, transmitted to the user device(s) 160, and presented on display(s) of the user device(s) 160. The status alerts 330 may be associated with particular users and/or user accounts (e.g., according to users assigned to corresponding workflow steps and/or report generation phases in the workflow configuration data 316) and may be transmitted to and/or presented on user devices 160 specifically associated with the particular users.

In one example, the workflow status tracking process 324 may be configured to determine whether the report status data 326 indicates that a particular workflow step and/or report generation phase (e.g., originally defined in the workflow configuration data 316) is assigned a particular status associated with being ready to be performed but not having been started and, in response to such a determination, to generate a status alert 330 indicating the particular status and sending the status alert 330 for presentation to the user device 160 associated with the particular step/phase. In another example, the workflow status tracking process 324 may be configured to periodically (e.g., according to predetermined and/or user-configurable periodic intervals of time) generate status alerts 330 for any workflow steps and/or report generation phases that remain incomplete. In another example, the workflow status tracking process 324 may be configured to monitor the report status data 326 to determine whether the status of any workflow steps and/or report generation phases has been updated to reflect completion of the steps/phases and to generate status alerts 330 for any succeeding steps/phases that are defined as occurring subsequent to the completed steps/phases and/or are defined as being dependent upon the completed steps/phases (e.g., in the workflow configuration data 316).

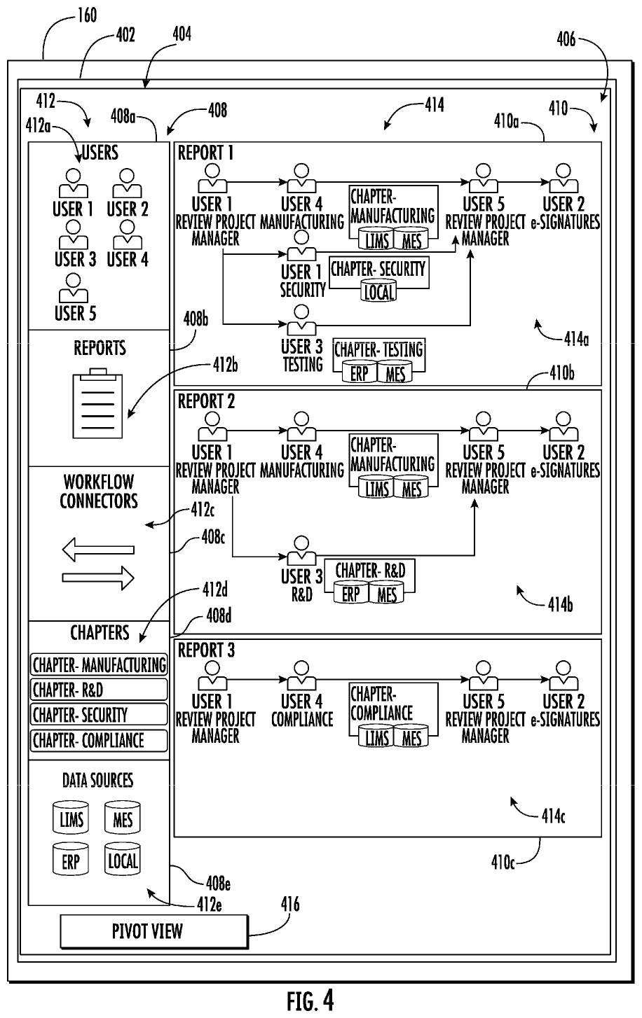

FIG. 4 is an illustration of an exemplary workflow configuration screen 406 (e.g., of the workflow configuration interface 310). The workflow configuration screen 406 may be presented within a GUI 404 rendered on a display 402 of a computing device such as a user device 160. The GUI 404 may be presented as part of a native application user interface or a user interface of a web application (e.g., rendered via a web browser application). The workflow configuration screen 406 comprises interactable elements configured to receive (e.g., as user input) the workflow configuration input (such as that embodied by the workflow configuration input 312 defined and described with respect to FIG. 3).

In various embodiments, the workflow configuration screen 406 may comprise one or more object selection panes 408, one or more quality report panes 410, and a via pivot button 416.

One or more of the object selection panes 408 may correspond to an object type associated with various objects (e.g., defined in the object data/metadata 308), including users (and/or user accounts), reports, report portions (e.g., chapters), and/or data sources, to list a few examples. Within each of the object selection panes 408 may be rendered one or more arrangeable graphical elements 412 associated with the object selection pane 408 and its corresponding object type. Each particular arrangeable graphical element 412 within a particular object selection pane 408 may represent a particular object (e.g., defined in the object data/metadata 308) of the corresponding object type, such that any selections and/or input (e.g., of the workflow configuration input 312) received (e.g., by the workflow configuration process 306 via the workflow configuration interface 310) with respect to the particular arrangeable graphical element 412 may be associated with and pertain to the particular object represented by the particular arrangeable graphical element 412.

Each of the quality report panes 410 may correspond to a particular quality report (e.g., of the quality reports 322 to be generated by the quality report generation system 120) and may be associated with a particular quality report workflow associated with generation of the particular quality report. More particularly, within one or more of the quality report panes 410 may be rendered a particular selected arrangement of graphical elements 414 of various types, the particular selected arrangement of graphical elements 414 representing the particular quality report workflow associated with the particular quality report corresponding to the quality report pane 410 such that the particular selected arrangement of graphical elements 414 may determine any workflow configuration data (such as that embodied in the workflow configuration data 316 described with respect to FIG. 3) that is generated with respect to the quality reports corresponding to the quality report panes 410.

In various embodiments, the selected arrangements of graphical elements 414 within the quality report panes 410 may be determined based at least in part on selections, interactions, and/or input (e.g., of the workflow configuration input 312) detected, registered, captured, and/or received by the workflow configuration interface 310 with respect to one or more of the various arrangeable graphical elements 412 within the object selection panes 408. The selections, interactions, and/or input detected, registered, captured, and/or received with respect to the arrangeable graphical elements 412 may include any interactions (e.g., between a user and the workflow configuration screen 406) indicating and/or representing movement of the arrangeable graphical elements 412 from the object selection panes 408 into the quality report panes 410 and, more particularly, to particular positions with respect to the quality report panes 410, particular relative positions with respect to other graphical elements within the quality report panes 410, and/or particular positions in contact or connection with other graphical elements within the quality report panes 410, to list a few examples. For example, the selections, interactions, and/or input detected, registered, captured, and/or received with respect to the arrangeable graphical elements 412 may include drag-and-drop operations with respect to the arrangeable graphical elements 412 and the quality report panes 410 (and/or any graphical elements contained within), including, in one example, a drag-and-drop operation effecting a simulated movement (and/or copying) of an arrangeable graphical element 412 from an object selection pane 408 to a particular position within a quality report pane 410. In some embodiments, the selected arrangements of graphical elements 414 may be effected by, determined by, and/or result from combinations of such drag-and-drop operations with respect to various arrangeable graphical elements 412 from various object selection panes 408.

In some embodiments, the object selection pane(s) 408 of the workflow configuration screen 406 may comprise a user selection pane 408a, which may correspond to an object type associated with users and/or user accounts (e.g., defined in the object data/metadata 308). Within the user selection pane 408a may be rendered one or more arrangeable user graphical elements 412a, each of which may be associated with a particular user and/or user account (e.g., defined in the object data/metadata 308), such that any selections and/or input received with respect to a particular arrangeable user graphical element 412a may be associated with and pertain to the particular user and/or user account represented by the particular arrangeable user graphical element 412a. More particularly, input and/or selections effecting movement and/or copying of a particular arrangeable user graphical element 412a from the user selection pane 408a into a quality report pane 410 as part of the selected arrangement of graphical elements 414 within the quality report pane may indicate and/or represent creation of a new workflow step and/or report generation phase and/or assignment of the particular user and/or user account to a workflow step and/or report generation phase.

In some embodiments, the object selection pane(s) 408 of the workflow configuration screen 406 may comprise a report selection pane 408b, which may correspond to an object type associated with quality reports (e.g., to be generated by the quality report generation system 120). Within the report selection pane 408a may be rendered an arrangeable report graphical element 412b, which may be associated with a new quality report, such that particular selections and/or input received with respect to the arrangeable report graphical element 412b may be associated with and pertain to a newly created and/or defined quality report. More particularly, input and/or selections effecting movement and/or copying of the arrangeable report graphical element 412b from the report selection pane 408b into a region containing the quality report pane(s) 410 (e.g., but not within one of the quality report pane(s) 410) may indicate and/or represent creation of a new report generation workflow associated with a newly created and/or newly defined quality report. In response to receiving such input, for example, the workflow configuration interface 310 may be configured to update the workflow configuration screen 406 to include an additional quality report pane 410 associated with the newly created and/or newly defined quality report, and the additional quality report pane 410 may be rendered as an empty pane (e.g., without any graphical elements and/or selected arrangements thereof within the pane) until subsequent input and/or selections are received with respect to the additional quality report pane 410.

In some embodiments, the object selection pane(s) 408 of the workflow configuration screen 406 may comprise a connector selection pane 408c, which may correspond to an object type associated with relationships between users and/or, more particularly, relationships between workflow steps and/or report generation phases to which the users are assigned. Within the connector selection pane 408c may be rendered one or more arrangeable connector graphical elements 412c, each of which may be associated with a type of relationship, such that particular selections and/or input received with respect to a particular connector graphical element 412c may be associated with and pertain to a newly created and/or defined connection (of the type of relationship associated with the particular connector graphical element 412c) between a pair of graphical elements included within the selected arrangements of graphical elements 414 within the quality report panes 410. More particularly, input and/or selections effecting movement and/or copying of a particular connector graphical element 412c from the connector selection pane 408c into a quality report pane 410 connecting a pair of graphical elements included in the selected arrangement of graphical elements 414 within the quality report pane may indicate and/or represent connection between a first workflow step and/or report generation phase and a second workflow step and/or report generation phase, establishing, for example, a sequential relationship between the first and second step(s)/phase(s) (e.g., with the first preceding the second in the sequence).

In some embodiments, the object selection pane(s) 408 of the workflow configuration screen 406 may comprise a chapter selection pane 408d, which may correspond to an object type associated with chapters (e.g., defined in the object data/metadata 308). Within the chapter selection pane 408d may be rendered one or more arrangeable chapter graphical elements 412d, each of which may be associated with a particular chapter type (e.g., defined in the object data/metadata 308) for chapters included in quality reports, such that any selections and/or input received with respect to a particular arrangeable chapter graphical element 412d may be associated with and pertain to the particular chapter type represented by the particular arrangeable chapter graphical element 412d. More particularly, input and/or selections effecting movement and/or copying of a particular arrangeable chapter graphical element 412d from the chapter selection pane 408d into a quality report pane 410 as part of the selected arrangement of graphical elements 414 within the quality report pane may indicate and/or represent creation of a new workflow step and/or report generation phase and/or assignment of the particular chapter type to a workflow step and/or report generation phase.

In some embodiments, the object selection pane(s) 408 of the workflow configuration screen 406 may comprise a data source selection pane 408e, which may correspond to an object type associated with data sets (e.g., defined in the object data/metadata 308). Within the data source selection pane 408e may be rendered one or more arrangeable data source graphical elements 412e, each of which may be associated with a particular data source and/or data set (e.g., defined in the object data/metadata 308), such that any selections and/or input received with respect to a particular arrangeable data source graphical element 412e may be associated with and pertain to the particular data set represented by the particular arrangeable data source graphical element 412e. More particularly, input and/or selections effecting movement and/or copying of a particular arrangeable data source graphical element 412e from the data source selection pane 408e into a quality report pane 410 as part of the selected arrangement of graphical elements 414 within the quality report pane may indicate and/or represent creation of a new workflow step and/or report generation phase and/or assignment of the particular data set to a workflow step and/or report generation phase.

In some embodiments, the workflow configuration screen 406 may comprise one or more interactable elements in addition to those embodied in the arrangeable object graphical elements 412, which graphical elements may be configured to receive other types of input (e.g., of the workflow configuration input 312) such as selections (e.g., from among various objects defined in the object data/metadata 308, from among various predefined sets and/or hierarchies of data objects corresponding to predefined components of quality reports) and/or text input in connection with the various arrangements of the graphical elements 414 within the quality report panes 410.

In the illustrated example, the workflow configuration screen 406 comprises the user selection pane 408a, the report selection pane 408b, the connector selection pane 408c, the chapter selection pane 408d, and the data source selection pane 408e. The user selection pane 408a comprises five arrangeable user graphical elements 412a representing, respectively, a first user (“User1”), a second user (“User2”), a third user (“User3”), a fourth user (“User4”), and a fifth user (“User5”), each of which, for example, may correspond to a user and/or user account defined in the object data/metadata 308. The chapter selection pane 408d comprises four arrangeable chapter graphical elements 412d representing, respectively, a first chapter type (“Manufacturing”), a second chapter type (“R&D”), a third chapter type (“Security”), and a fourth chapter type (“Compliance”). The data source selection pane 408e comprises four arrangeable data source graphical elements 412e representing, respectively, a first data set (“LIMS”), a second data set (“MES”), a third data set (“ERP”), and a fourth data set (“Local”).

Moreover, in the illustrated example, the workflow configuration screen 406 comprises a first quality report pane 410a, a second quality report pane 410b, and a third quality report pane 410c. The first quality report pane 410a comprises a first selected arrangement of graphical elements 414a, the second quality report pane 410b comprises a second selected arrangement of graphical elements 414b, and the third quality report pane 410c comprises a third selected arrangement of graphical elements 414c. Each of the selected arrangements of graphical elements 414a, 414b, 414c includes a graphical element corresponding to a first report generation phase, one or more graphical elements corresponding to a second report generation phase, a graphical element corresponding to a fourth report generation phase, and a graphical element corresponding to a fifth report generation phase, with the graphical element corresponding to the first report generation phase connected to the one or more graphical elements corresponding to the second report generation phase via connector graphical elements, the one or more graphical elements corresponding to the second report generation phase connected to the graphical element corresponding to the third report generation phase via connector graphical elements, and the graphical element corresponding to the third report generation phase connected to the graphical element corresponding to the fourth report generation phase via a connector graphical element.

Moreover, in the illustrated example, in each of the selected arrangements of graphical elements 414a, 414b, 414c, the graphical element for the first report generation phase corresponds to a workflow step assigned to the user and/or user account “User1”, the graphical element for the third report generation phase corresponds to a workflow step assigned to the user and/or user account “User 5”, and the graphical element for the fourth report generation phase corresponds to a workflow step assigned to the user and/or user account “User 2”. However, in the first selected arrangement of graphical elements 414a, the second report generation phase corresponds to a combination of three sets of graphical elements, each set representing a distinct workflow step in the second report generation phase, the first set being assigned to the user and/or user account “User4”, the chapter type “Manufacturing”, and the data sets “LIMS” and “MES”, the second set being assigned to the user and/or user account “User1”, the chapter type “Security”, and the data set “Local”, and the third set being assigned to the user and/or user account “User3”, the chapter type “Testing”, and the data sets “ERP” and “MES”. On the other hand, in the second selected arrangement of graphical elements 414b, the second report generation phase corresponds to a combination of two sets of graphical elements, each set representing a distinct workflow step in the second report generation phase, the first set being assigned to the user and/or user account “User4”, the chapter type “Manufacturing”, and the data sets “LIMS” and “MES”, and the second set being assigned to the user and/or user account “User3”, the chapter type “R&D”, and the data sets “ERP” and “MES”. In the third selected arrangement of graphical elements 414c, the second report generation phase corresponds to a single set of graphical elements representing a distinct workflow step in the second report generation phase assigned to the user and/or user account “User4”, the chapter type “Compliance”, and the data sets “LIMS” and “MES”.

In the example illustrated in FIG. 4, the workflow configuration input 312 may comprise, in aggregate, data defining, identifying, and/or characterizing all of the selections, interactions, and/or input received via the workflow configuration screen 406 with respect to the arrangeable object graphical elements 412 included in the various object selection panes 408 and the various quality report panes 410 effecting the selected arrangements of graphical elements 414a, 414b, 414c rendered within each of the quality report panes 410a, 410b, 410c, including, for example, any drag-and-drop operations moving/copying the various arrangeable object graphical elements 412 from the object selection panes 408 to respective corresponding positions (e.g., within the panes, relative positions with respect to each other, positions in contact/connection with respect to each other) within the quality report panes 410a, 410b, 410c.

Moreover, in the example illustrated in FIG. 4, the parsing criteria 314 may comprise definitions of various types of workflow steps and/or types of phases in the report generation process, which definitions may be expressed with respect to one or more references to and/or identifiers and/or attributes associated with the objects represented by the various arrangeable object graphical elements 412. More particularly, the parsing criteria 314 may be defined such that the various arrangements of graphical elements 414 provided within each quality report pane 410 are interpretable by the workflow configuration process 306 in generating the workflow configuration data 316 corresponding to each of the quality reports represented by each of the quality report panes 410, the resulting workflow configuration data 316 defining a quality report generation workflow according to the corresponding visual/graphical representation provided via the arrangements of graphical elements 414. In one example, in response to receiving the workflow configuration input 312 corresponding to the various selected arrangements of graphical elements 414 within the quality report panes 410, the workflow configuration process 306 may be configured to generate the workflow configuration data 316 to comprise a definition of a quality report generation workflow corresponding to each of the quality report panes 410 based at least in part on the selected arrangement of graphical elements 414 and the parsing criteria 314, each definition representing the workflow according to the graphical depiction of the workflow provided via the selected arrangements of graphical elements.

More particularly, in some embodiments, the parsing criteria 314 may define various types of workflow step(s), types of phases in the report generation process, and/or types of relationships between objects (e.g., defined in the object data/metadata 308), with each of these defined types being associated with a representation of a type of arrangement of graphical elements that may occur within the quality report pane(s) (and corresponding workflow configuration input 312) and may be indicative of and/or representative of the defined type. The workflow configuration process 306 may be configured to generate the workflow configuration data 316 by determining whether any of the types of arrangements of graphical elements defined in the parsing criteria 314 correspond to (or match) any of the selected arrangements of graphical elements indicated in the workflow configuration input 312 and, for each correspondence (or match) between a type of arrangement defined in the parsing criteria 314 and a selected arrangement indicated in the workflow configuration input 312, including in the workflow configuration data 316 a definition of a particular workflow step, report generation phase, and/or relationship of the type corresponding to the matching arrangement in the parsing criteria 314. The workflow configuration process 306 may be configured to generate (e.g., as part of the workflow configuration data 316) each definition of a particular workflow step, report generation phase, and/or relationship with respect to particular objects (e.g., defined in the object data/metadata 308) based at least in part on references to the particular objects included in the workflow configuration input 312 and associated with the selected arrangements of graphical elements. In this way, for example, the workflow configuration process 306 may be configured to combine and/or cross-reference the particular workflow configuration input 312 received via the workflow configuration interface 310 with the predefined parsing criteria 314 in order to derive, determine, and/or define a representation of a report generation workflow.

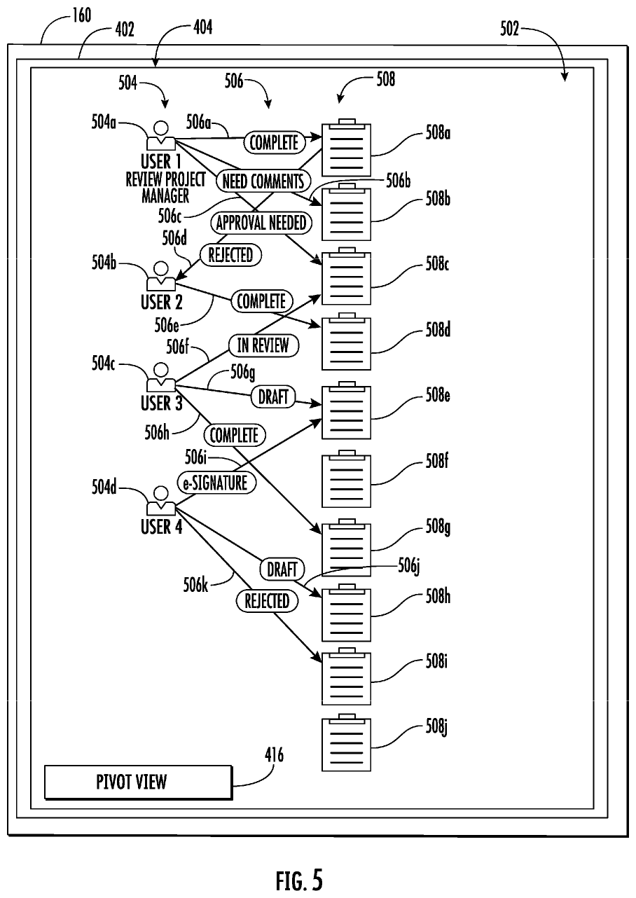

FIG. 5 is an illustration of an exemplary workflow status tracking screen 502 (e.g., of the workflow status tracking interface 328). The workflow status tracking screen 502 may be presented within a GUI 404 rendered on a display 402 of a computing device such as a user device 160. The GUI 404 may be presented as part of a native application user interface or a user interface of a web application (e.g., rendered via a web browser application). The workflow status tracking screen 502 may be configured to display report status data (e.g., embodied in the report status data 326) generated by the quality report generation system 120.

In various embodiments, the workflow status tracking screen 502 may comprise status graphical elements arranged with respect to each other and/or having visual characteristics based at least in part on the report status data 326 such that the arrangement of the status graphical elements and/or visual characteristics thereof are visually and/or graphically indicative of the report status data 326. More particularly, in some embodiments, these status graphical elements of the workflow status tracking screen 502 may comprise user status graphical elements 504, workflow step status graphical elements 506, and report status graphical elements 508.

In various embodiments, each of the user status graphical elements 504 may represent a user and/or user account (e.g., defined in the object data/metadata 308). In one example, the users/accounts represented by the user status graphical elements 504 may correspond to the users/accounts represented by the arrangeable user graphical elements 412a in the user selection pane 408a of the workflow configuration screen 406. In another example, the users/accounts represented by the user status graphical elements 504 may correspond to the users/accounts assigned to the various workflow steps configured and depicted via the selected arrangements of graphical elements 414 within the quality report panes 410 of the workflow configuration screen 406.

In various embodiments, each of the workflow step status graphical elements 506 may represent a workflow step configured and depicted via the selected arrangements of graphical elements 414 within the quality report panes 410 of the workflow configuration screen 406.

In various embodiments, each of the report status graphical elements 508 may represent a report (e.g., of the quality reports 322) for which a workflow has been configured via the selected arrangements of graphical elements 414 within the quality report panes 410 of the workflow configuration screen 406. In one example, each of the reports represented by the report status graphical elements 508 may correspond to a report associated with a quality report pane 410 of the workflow configuration screen 406.

In various embodiments, the arrangement of the workflow step status graphical elements 506 with respect to the user status graphical elements 504 and the report status graphical elements 508, as depicted via the workflow status tracking screen 502 may be determined based at least in part on the workflow configuration data 316 (e.g., generated by the workflow configuration process 306) and/or the report status data 326 (e.g., generated by the quality report generation system 120) such that the arrangement is visually and/or graphically indicative and/or representative of the various workflow steps. For example, each of the workflow step status graphical elements 506 may be visually and/or graphically interposed (e.g., as a connector) between one of the user status graphical elements 504 and one of the report status graphical elements 508 providing a visual/graphical depiction of a corresponding workflow step defined for the quality report in question (e.g., the workflow step pertaining to the report represented by the report status graphical element 508 to which the user represented by the user status graphical element 504 is assigned).

Moreover, in various embodiments, visual characteristics of the workflow step status graphical elements 506 may be determined based at least in part on the report status data 326 such that the visual characteristics are indicative and/or representative of data provided in the report status data 326. For example, each of the workflow step status graphical elements 506 may be rendered in a hue and/or color (e.g., green, orange, yellow, red) corresponding to a status associated with the corresponding workflow step as indicated in the report status data 326. In another example, each of the workflow step status graphical elements 506 may be rendered along with corresponding text data (e.g., “Complete”, “Need comments”, “Approval Needed”, “Rejected”, In Review”, “Draft”, “e-Signature”) corresponding to a status associated with the corresponding workflow step as indicated in the report status data 326.

In the illustrated example, the workflow status tracking screen 502 comprises four user status graphical elements 504a-504d (respectively corresponding to “User1”, “User2”, “User3”, and “User4”), eleven workflow step status graphical elements 506a-506k, and ten report status graphical elements 508a-508j. The first workflow step status graphical element 506a connects the first user status graphical element 506a with the first report status graphical element 508a, indicating that the first workflow step status graphical element 506a represents a workflow step pertaining to the report represented by the first report status graphical element 508a and assigned to the user represented by the first user status graphical element 506a. The remaining workflow step status graphical elements 506b-506k establish similar, analogous connections between the various user status graphical elements 504a-504d and report status graphical elements 508a-508j. Moreover, in the illustrated example, the visual characteristics of the workflow step status graphical elements 506a-506k are based at least in part on the report status data 326 such that the visual characteristics are indicative and/or representative of data provided in the report status data 326. For example, the first workflow step status graphical element 506a is rendered in a hue/color (e.g., green) and is rendered along with corresponding text data (e.g., “Complete”), with the hue/color and text data being those associated (e.g., via predetermined configuration data) with the status indicated with respect to the corresponding workflow step in the report status data 326. Similarly, the remaining workflow step status graphical elements 506b-506k have similar visual characteristics based at least in part on the report status data 326.

Both the workflow configuration screen 406 and the workflow status tracking screen 502 may be configured such that the pivot view button 416 enables pivoting between the two screens. For example, in response to selection and/or activation of the pivot view button 416 on the workflow configuration screen 406, the workflow configuration system 140 may be configured to update the display to change from the workflow configuration screen 406 to the workflow status tracking screen 502. Similarly, in response to selection and/or activation of the pivot view button 416 on the workflow status tracking screen 502, the workflow configuration system 140 may be configured to update the display to change from the workflow status tracking screen 502 to the workflow configuration screen 406.

Having described example systems and/or apparatuses of the present disclosure, example flowcharts including various operations performed by the apparatuses and/or systems described herein will now be discussed. It should be appreciated that each of the flowcharts depicts an example computer-implemented process that may be performed by one or more of the apparatuses, systems, and/or devices described herein, for example utilizing one or more of the components thereof. The blocks indicating operations of each process may be arranged in any of a number of ways, as depicted and described herein. In some such embodiments, one or more blocks of any of the processes described herein occur in-between one or more blocks of another process, before one or more blocks of another process, and/or otherwise operates as a sub-process of a second process. Additionally or alternatively, any of the processes may include some or all of the steps described and/or depicted, including one or more optional operational blocks in some embodiments. With respect to the flowcharts discussed below, one or more of the depicted blocks may be optional in some, or all, embodiments of the disclosure. Similarly, it should be appreciated that one or more of the operations of each flowchart may be combinable, replaceable, and/or otherwise altered as described herein.

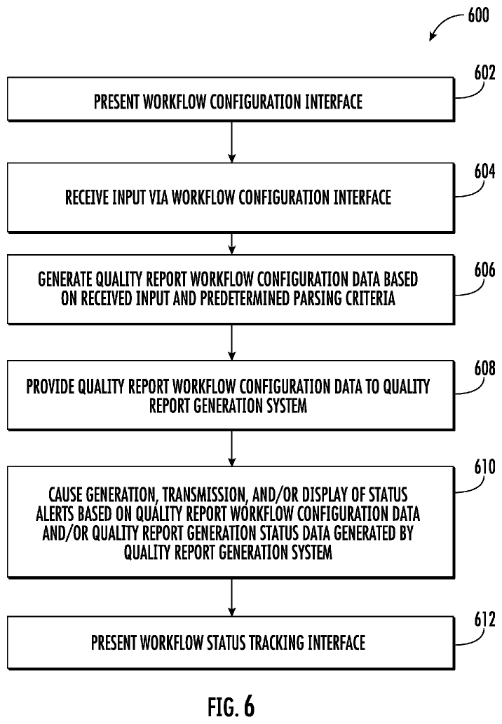

FIG. 6 illustrates a flowchart including operational blocks of an example process in accordance with at least some example embodiments of the present disclosure. In some embodiments, the computer-implemented process of FIG. 6 is embodied by computer program code stored on a non-transitory computer-readable medium of a computer program product configured for execution to perform the computer-implemented method. Alternatively or additionally, in some embodiments, the example process of FIG. 6 is performed by one or more specially configured computing devices, such as the specially configured apparatus 200 (e.g., via workflow configuration circuitry 210, integration circuitry 212, status alert circuitry 214, workflow status tracking circuitry 216, and/or quality report generation circuitry 218). In this regard, in some such embodiments, the apparatus 200 is specially configured by computer program instructions stored thereon, for example in the memory 204 and/or another component depicted and/or described herein, and/or otherwise accessible to the apparatus 200, for performing the operations as depicted and described with respect to the example process of FIG. 6. In some embodiments, the specially configured apparatus 200 includes and/or otherwise is in communication with one or more external apparatuses, systems, devices, and/or the like, to perform one or more of the operations as depicted and described. While the operational blocks of the example process are depicted in FIG. 6 in a particular order, this should not be understood as requiring that such operations be performed in the particular order shown or in sequential order, or that all illustrated operations be performed.

FIG. 6 illustrates a flowchart including operational blocks of an example process 600 for configuring and tracking report generation workflows for quality reports, in accordance with at least some example embodiments of the present disclosure.

The process 600 begins at operation 602, at which an apparatus (such as, but not limited to, the apparatus 200 or circuitry thereof as described above in connection with FIG. 2) presents a workflow configuration interface comprising one or more quality report panes, each of which may correspond to a quality report to be generated and to a workflow associated with generation of the quality report. Additionally or alternatively, the workflow configuration interface presented at operation 602 may correspond to and/or comprise the workflow configuration interface 310 as defined and described with respect to FIG. 3, and presenting the workflow configuration interface at operation 602 may comprise some or all of the analogous functionality attributed to the workflow configuration process 306 as described with respect to FIG. 3. Additionally or alternatively, the workflow configuration interface presented at operation 602 may correspond to and/or comprise the workflow configuration screen 406 as depicted in FIG. 4 and described with respect to FIG. 4, and the quality report pane(s) of the workflow configuration interface presented at operation 602 may correspond to and/or comprise the quality report panes 410 of the workflow configuration screen 406 as described with respect to FIG. 4.

At operation 604 of the process 600, an apparatus (such as, but not limited to, the apparatus 200 or circuitry thereof described above in connection with FIG. 2) receives input via the workflow configuration interface presented at operation 602, the received input being indicative of selected arrangements of graphical elements within one or more quality report panes of the workflow configuration interface presented at operation 602. In various embodiments, the input received at operation 604 may correspond to and/or comprise the workflow configuration input 312 as defined and described with respect to FIG. 3, and receiving the input at operation 604 may comprise some or all of the analogous functionality as described with respect to FIG. 3. Additionally or alternatively, the selected arrangements of graphical elements indicated by the input received at operation 604 may correspond to and/or comprise the selected arrangements of graphical elements 414 as depicted and described with respect to FIG. 4.

At operation 606 of the process 600, an apparatus (such as, but not limited to, the apparatus 200 or circuitry thereof described above in connection with FIG. 2) generates quality report workflow configuration data corresponding to each quality report pane of the workflow configuration interface presented at operation 602 based at least in part on the selected arrangement of graphical elements within the quality report pane (as indicated in the input received at operation 604) and on predetermined graphical element arrangement parsing criteria. In various embodiments, the quality report workflow configuration data generated at operation 606 may correspond to and/or comprise the workflow configuration data 316 as defined and described with respect to FIG. 3, the predetermined graphical element arrangement parsing criteria referenced with respect to operation 606 may correspond to and/or comprise the parsing criteria 314 as defined and described with respect to FIG. 3, and generating the quality report workflow configuration data at operation 606 may comprise some or all of the analogous functionality attributed to the workflow configuration process 306 as described with respect to FIG. 3.

At operation 608 of the process 600, an apparatus (such as, but not limited to, the apparatus 200 or circuitry thereof described above in connection with FIG. 2) provides the quality report workflow configuration data generated at operation 606 to the quality report generation system 120. In various embodiments, the quality report generation system 120 may be configured to generate quality reports based at least in part on the quality report workflow configuration data provided at operation 608, which generated quality reports may correspond to and/or comprise the quality reports 322 as defined and described with respect to FIG. 3, and generating the quality reports based on the data provided at operation 608 may comprise some or all of the analogous functionality attributed to the quality report generation system 120 as described with respect to FIG. 3.

At operation 610 of the process 600, an apparatus (such as, but not limited to, the apparatus 200 or circuitry thereof described above in connection with FIG. 2) causes generation, transmission, and/or display of status alerts based at least in part on the quality report workflow configuration data (generated at operation 606) and/or based at least in part on quality report generation status data generated by the quality report generation system. In various embodiments, the status alerts referenced with respect to operation 610 may correspond to and/or comprise the status alerts 330 as defined and described with respect to FIG. 3, the quality report generation status data referenced with respect to operation 610 may correspond to and/or comprise the report status data 326 as defined and described with respect to FIG. 3, and causing generation, transmission, and/or presentation of the status alerts at operation 610 may comprise some or all of the analogous functionality attributed to the workflow status tracking process 324 as described with respect to FIG. 3.

At operation 612 of the process 600, an apparatus (such as, but not limited to, the apparatus 200 or circuitry thereof described above in connection with FIG. 2) presents a workflow status tracking interface configured for displaying quality report generation status data generated by the quality report generation system 120 (e.g., based on and/or in connection with performance of quality report generation operations by the quality report generation system 120 based at least in part on the quality report workflow configuration data generated at operation 606). In various embodiments, the workflow status tracking interface presented at operation 612 may correspond to and/or comprise the workflow status tracking interface 328 as defined and described with respect to FIG. 3, the quality report generation status data referenced with respect to operation 610 may correspond to and/or comprise the report status data 326 as defined and described with respect to FIG. 3, and presenting the workflow status tracking interface 328 at operation 612 may comprise some or all of the analogous functionality attributed to the workflow status tracking process 324 as described with respect to FIG. 3. Additionally or alternatively, the workflow status tracking interface presented at operation 612 may correspond to and/or comprise the workflow status tracking screen 502 as depicted in FIG. 5 and described with respect to FIG. 5.

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communications network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communications network. Examples of communications networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communications network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed is:

1. An apparatus comprising at least one processor and at least one non-transitory memory comprising program code stored thereon, wherein the at least one non-transitory memory and the program code are configured to, with the at least one processor, cause the apparatus to at least:
present a workflow configuration interface comprising one or more quality report panes, wherein each quality report pane of the one or more quality report panes corresponds to a quality report to be generated and to a workflow associated with generation of the quality report;
receive, via the workflow configuration interface, input indicative of selected arrangements of graphical elements within the one or more quality report panes; and
generate quality report workflow configuration data corresponding to each quality report pane of the one or more quality report panes based at least in part on the selected arrangement of graphical elements within the quality report pane and on predetermined graphical element arrangement parsing criteria,
wherein the quality report corresponding to each quality report pane of the one or more quality report panes is generated based at least in part on the quality report workflow configuration data corresponding to the quality report pane.

2. The apparatus of claim 1, wherein the graphical elements comprise object graphical elements that represent objects associated with the generation of the quality reports, including particular users, particular reports to be generated, quality report section types, and/or data sources used to generate the quality reports, and connector graphical elements representing relationships between objects represented by the object graphical elements.

3. The apparatus of claim 1, wherein receiving the input indicative of the selected arrangements of graphical elements within the one or more quality report panes comprises detecting drag-and-drop operations via the workflow configuration interface with respect to graphical elements displayed within the workflow configuration interface.

4. The apparatus of claim 1, wherein the predetermined graphical element arrangement parsing criteria comprises a definition of one or more arrangements between graphical elements of particular types, each arrangement associated with a quality report generation workflow stage represented by the arrangement.

5. The apparatus of claim 1, wherein the at least one non-transitory memory and the program code are configured to, with the at least one processor, further cause the apparatus to at least:
cause generation, transmission, and/or display of status alerts based at least in part on the quality report workflow configuration data.

6. The apparatus of claim 1, wherein the at least one non-transitory memory and the program code are configured to, with the at least one processor, further cause the apparatus to at least:
provide the quality report workflow configuration data to a quality report generation system, which is configured to perform one or more quality report generation operations based at least in part on the quality report workflow configuration data.

7. The apparatus of claim 6, wherein the quality report generation system is configured to generate quality report generation status data based at least in part on performance of the one or more quality report generation operations.

8. The apparatus of claim 7, wherein the at least one non-transitory memory and the program code are configured to, with the at least one processor, further cause the apparatus to at least:
present a workflow status tracking interface for displaying the quality report generation status data generated by the quality report generation system.

9. The apparatus of claim 7, wherein the at least one non-transitory memory and the program code are configured to, with the at least one processor, further cause the apparatus to at least:
cause generation, transmission, and/or display of status alerts based at least in part on the quality report generation status data generated by the quality report generation system.

10. The apparatus of claim 1, wherein the quality report corresponding to each quality report pane of the one or more quality report panes is associated with a pharmaceutical research, manufacturing, and/or distribution process, and the predetermined graphical element arrangement parsing criteria is configured specifically with respect to laboratory, production line, and/or material handling operations associated with the pharmaceutical research, manufacturing, and/or distribution process.

11. A computer-implemented method comprising:
presenting a workflow configuration interface comprising one or more quality report panes, wherein each quality report pane of the one or more quality report panes corresponds to a quality report to be generated and to a workflow associated with generation of the quality report;
receiving, via the workflow configuration interface, input indicative of selected arrangements of graphical elements within the one or more quality report panes; and
generating quality report workflow configuration data corresponding to each quality report pane of the one or more quality report panes based at least in part on the selected arrangement of graphical elements within the quality report pane and on predetermined graphical element arrangement parsing criteria,
wherein the quality report corresponding to each quality report pane of the one or more quality report panes is generated based at least in part on the quality report workflow configuration data corresponding to the quality report pane.

12. The method of claim 11, wherein the graphical elements comprise object graphical elements that represent objects associated with the generation of the quality reports, including particular users, particular reports to be generated, quality report section types, and/or data sources used to generate the quality reports, and connector graphical elements representing relationships between objects represented by the object graphical elements.

13. The method of claim 11, wherein receiving the input indicative of the selected arrangements of graphical elements within the one or more quality report panes comprises detecting drag-and-drop operations via the workflow configuration interface with respect to graphical elements displayed within the workflow configuration interface.

14. The method of claim 11, wherein the predetermined graphical element arrangement parsing criteria comprises a definition of one or more arrangements between graphical elements of particular types, each arrangement associated with a quality report generation workflow stage represented by the arrangement.

15. The method of claim 11, further comprising causing generation, transmission, and/or display of status alerts based at least in part on the quality report workflow configuration data.

16. The method of claim 11, further comprising providing the quality report workflow configuration data to a quality report generation system, which is configured to perform one or more quality report generation operations based at least in part on the quality report workflow configuration data.

17. The method of claim 16, wherein the quality report generation system is configured to generate quality report generation status data based at least in part on performance of the one or more quality report generation operations.

18. The method of claim 17, further comprising presenting a workflow status tracking interface for displaying the quality report generation status data generated by the quality report generation system.

19. The method of claim 17, further comprising causing generation, transmission, and/or display of status alerts based at least in part on the quality report generation status data generated by the quality report generation system.

20. A computer program product comprising at least one non-transitory computer-readable storage medium having computer-readable program code portions stored therein, the computer-readable program code portions comprising an executable portion configured to:
present a workflow configuration interface comprising one or more quality report panes, wherein each quality report pane of the one or more quality report panes corresponds to a quality report to be generated and to a workflow associated with generation of the quality report;
receive, via the workflow configuration interface, input indicative of selected arrangements of graphical elements within the one or more quality report panes; and
generate quality report workflow configuration data corresponding to each quality report pane of the one or more quality report panes based at least in part on the selected arrangement of graphical elements within the quality report pane and on predetermined graphical element arrangement parsing criteria,
wherein the quality report corresponding to each quality report pane of the one or more quality report panes is generated based at least in part on the quality report workflow configuration data corresponding to the quality report pane.
